(19) United States
(12) Patent Application Publication
(10) Pub. No.: US 2007/0120868 A1
(43) Pub. Date: May 31, 2007

(54) METHOD AND APPARATUS FOR DISPLAYING AN IMAGE

(76) Inventor: Jong-Hak Baek, Yongin-si (KR)

Correspondence Address: F. CHAU & ASSOCIATES, LLC, 130 WOODBURY ROAD, WOODBURY, NY, 11797, US

(21) Appl. No.: 11/563,358

(22) Filed: Nov. 27, 2006

(30) Foreign Application Priority Data
Nov. 28, 2005 (KR) 2005-114005

(51) Int. Cl. G09G 5/02

(52) U.S. Cl. 345/600

(57) ABSTRACT

A method for displaying an image, in which video data are received and M sub-frame gray signals are generated based on the received video data, where M is an integer no less than two. Each of the M sub-frame gray signals has N gray levels, and the M sub-frame gray signals include first through M-th sub-frame gray signals, where N is an integer no less than three. The M sub-frame gray signals are provided to a pixel array according to display times to display the image. The display times respectively correspond to each of the M sub-frame gray signals and are different from each other.

### CROSS-REFERENCE TO RELATED APPLICATION

This application claims priority to Korean Patent Application No. 2005-114005 filed on Nov. 28, 2005 in the Korean Intellectual Property Office (KIPO), the entire disclosure of which is herein incorporated by reference.

### BACKGROUND OF THE INVENTION

1. Technical Field

The present disclosure relates to a display device and, more particularly, to a method and apparatus for displaying an image capable of representing gray levels with a reduced number of sub-frames.

2. Discussion of the Related Art

A flat display device of the next generation may include an organic light-emitting diode (OLED) display device.

Generally, the OLED device may be classified into a passive matrix type and an active matrix type, according to the driving method employed in the OLED device. In the passive matrix method, brightness is controlled based on a duty ratio of a driving signal, and in the active matrix method, brightness is controlled based on a voltage level or a current amount. From the viewpoint of power consumption and image quality, the active matrix method has several advantages compared with the passive matrix method.

In developing an active matrix OLED device, characteristics of a thin-film transistor (TFT) that is included in a unit cell of a pixel array may, be troubled with various problems.

For example, in the active matrix OLED device including a back panel of amorphous silicon, a threshold voltage of the TFT may vary over time. Also, in the active matrix OLED device including a back panel of low-temperature polysilicon, a threshold voltage of the TFT may vary depending on a TFT location. That is, a stability problem may occur with reference to the back panel of amorphous silicon and a uniformity problem may occur with reference to the back panel of low-temperature polysilicon.

Recent research has been devoted to the development of a panel of the active matrix OLED device and a digital driving method has been introduced to solve the above-mentioned problems.

The digital driving method may be classified into a time ratio gray-scale (TRG) method and an area ratio gray-scale (ARC) method. In the TRG method, the brightness of a pixel is controlled based on a time ratio of a turn-on period and a turn-off period, whereas in the ARC method, the brightness is controlled according to an area ratio of a turn-on element to a turn-off element.

The TRG method is disclosed in U.S. Patent Application Publication No. 2004-27318, and the ARG method is disclosed in the literature, “Technology for active matrix light emitting polymer displays,” by T. Shimoda et al., IEDM, 1999.

Hereinafter, the TRG method will be described with reference to FIGS. 1 and 2, and the ARG method will be described with reference to FIG. 3.

FIG. 1 is a circuit diagram illustrating a pixel structure of an OLED device that is driven by a conventional TRG method.

Referring to FIG. 1, a pixel 100 includes a switch transistor 110 a cell capacitor 120, a driving transistor 130 and an LED 140.

A gate of the switch transistor 110 is coupled to a scan line 160. The switch transistor 110 is turned on or off according to a gate signal transmitted through the scan line 160. When the switch transistor 110 is turned on, a digital signal is transmitted to the cell capacitor 120 through a data line 150.

A gate of the driving transistor 130 is coupled to one terminal of the cell capacitor 120. The driving transistor 130 is turned on or off according to a voltage of the cell capacitor 120. When the driving transistor 130 is turned on, current flows through the LED 140 and when the driving transistor 130 is turned off, current does not flow through the LED 140.

The LED 140 may be an OLED including a light-emitting polymer, and the LED 140 emits light in proportion to the current flowing through the LED. Such a pixel may represent two gray levels. The TRG method may represent more varied gray levels.

FIG. 2 is a diagram for describing a conventional TRG method of displaying sixteen gray levels.

A row of a pixel array includes a plurality of pixels commonly coupled to a scan line, and the pixels commonly coupled to the scan tine receive pixel data through respective data lines. In FIG. 2, the method of displaying one pixel data per row as an example is illustrated, and the other pixels on the same row may be driven in the same way.

In order to represent a pixel with sixteen gray levels the display time for a pixel data may be divided into four sub-frames. For example, a ratio of lengths of the first sub-frame 210, the second sub-frame 220, the third sub-frame 230 and the fourth sub-frames 240 may correspond to 8:4:2:1.

The first, second, third and fourth sub-frames 210, 220, 230 and 240 include addressing periods 211, 221, 231 and 241, respectively, and a light-emitting periods 212, 222, 232 and 242, respectively. In the addressing period, a sub-frame signal is transmitted to the pixel, and in the light-emitting period, a pixel emits or does not emit light according to a logic level of the sub-frame signal. In the conventional TRG method, the sub-frame signal may have two states, that is, a high state or low state.

The time durations of the light-emitting periods may be controlled by a conventional means. For example, a switching element may be disposed on the path including the driving transistor 130 and the LED 140 to control the time duration of the light-emitting period. The time duration may be controlled by alternatively applying a ground voltage or a power supply voltage VDD to one terminal of the LED 140 with the other terminal connected to the power supply voltage VDD.

The four pixels are respectively coupled to four scan lines and respectively represent different gray levels with respect to FIG. 2. The first pixel in a first row is coupled to the first scan line and a gray level of the first pixel corresponds to a value of gray 15. The second pixel in a second row is coupled to the second scan line and a gray level of the second pixel corresponds to a value of gray 0. The third pixel in a third row is coupled to the third scan line and a gray level of the third pixel corresponds to a value of gray 3. The fourth pixel in a fourth row is coupled to the fourth scan line and a gray level of the fourth pixel corresponds to a value of gray 11.

In the first pixel representing a gray level corresponding to a value of gray 15, all data of the first through fourth sub-frames 210, 220, 230 and 240 correspond to a value of gray 1. In the second pixel representing a gray level corresponding to a value of gray 0, all data of the first through fourth sub-frames 210, 220, 230 and 240 correspond to a value of gray 0. In the third pixel representing a gray level corresponding to a value of gray 3, data of the first through fourth sub-frames 210, 220, 230 and 240 respectively correspond to values of gray 0, 0, 1 and 1. In the fourth pixel representing a gray level corresponding to a value of gray 11, data of the first through fourth sub-frames 210, 220, 230 and 240 respectively correspond to gray values of 1, 0, 1 and 1.

In the TRG method, the number of sub-frames is increased in proportion with the number of gray levels. For example, eight sub-frames are needed to represent data having 256 gray levels. The number of capacitors to be charged and discharged, however, is also increased in proportion the number of sub-frames and, thus, power consumption is increased.

FIG. 3 is a circuit diagram illustrating a pixel structure that is driven by a conventional ARG method.

Referring to FIG. 3, a single pixel includes a plurality of sub-pixels 310, 320, 330, 340, 350 and 360, and each of the sub-pixels includes a switching transistor, a storage capacitor, a driving transistor, and one or more LEDs. For example, each the sub-pixels 310, 320 and 330 may include two LEDs, and each of the sub-pixels 340, 350 and 360 may include a single LED.

All sub-pixels 310, 320, 330, 340, 350 and 360 share a scan line. Therefore, when the pixel is selected by the scan line, all switching transistors of the sub-pixels 310, 320, 330, 340, 350 and 360 are turned on. When the pixel is selected through the scan line, sub-pixel signals are transmitted through respective signal lines to storage capacitors in the sub-pixels 310, 320, 330, 340, 350 and 360. The sub-pixel signal is stored in the storage capacitors, respectively. Each of the sub-pixels 310, 320 and 330 includes two LEDs and each of the sub-pixels 340, 350 and 360 includes a single LED and, thus, brightness may be controlled.

In the ARG method in which a gray scale is displayed according to an area ratio, an aperture ratio is decreased and, thus, an amount of current flowing through the LED has to be increased in order to increase the brightness.

### SUMMARY OF THE INVENTION

Accordingly, exemplary embodiments of the present invention are provided to substantially obviate one or more problems due to limitations and disadvantages of the related art.

Exemplary embodiments of the present invention provide a method and apparatus for displaying an image capable of representing gray levels with a reduced number of sub-frames.

In exemplary embodiments of the present invention, a method for displaying an image includes receiving video data; generating M sub-frame gray signals based on the received video data, each of the M sub-frame gray signals having N gray levels, in which the M sub-frame gray signals include first through M-th sub-frame gray signals, M being an integer no less than two, N being an integer no less than three; and providing the M sub-frame gray signals to a pixel array according to display times to display the image, the display times respectively corresponding to each of the M sub-frame gray signals and being different from each other.

For example, the display time corresponding to the K-th sub-frame gray signal may be proportional to N^{K}, where K is a integer no less than one and not greater than M.

The first through M-th sub-frame gray signals may be sequentially provided to the pixel array. Alternatively the first through M-th sub-frame gray signals may be provided to the pixel array in a reverse order.

The integer N may correspond to 2^{L}, where L is an integer, no less than two.

In exemplary, embodiments of the present invention, an apparatus for displaying an image includes means for receiving video data; means for generating M sub-frame gray signals based on the received video data, each of the M sub-frame gray signals having N gray levels, in which the M sub-frame gray signals include first through M-th sub-frame gray signals, M being an integer no less than two, N being an integer no less than three; and means for providing the M sub-frame gray signals to a pixel array according to display times to display the image, the display times respectively corresponding to each of the M sub-frame gray signals and being different from each other.

The display time corresponding to the K-th sub-frame gray signal of the M sub-frame gray signals may be proportional to N^{K}, where K is an integer no less than one and not greater than M.

The first through M-th sub-frame gray signals may be sequentially provided to the pixel array. Alternatively the first through M-th sub-frame gray signals may be provided to the pixel array in a reverse order.

The integer N may correspond to 2^{L}, where L is an integer no less than two.

In exemplary embodiments of the present invention an apparatus for displaying an image includes: a controller configured to generate M sub-frame gray data and a sub-frame synchronization signal based on received video data and a received video synchronization signal, each of the M sub-frame gray signals having gray levels, M being an integer no less than two, N being an integer no less than three; a data driver configured to convert the M sub-frame gray data into M sub-frame gray signals, and configured to provide the M sub-frame gray signals to a pixel array according to a display times, in which the M sub-frame gray signals include first through M-th sub-frame gray signals, the display times respectively corresponding to each of the M sub-frame gray signals and being different from each other; and a gate driver configured to provide scan signals to the pixel array in response to the sub-frame synchronization signal, so that the M sub-frame gray signals are sequentially stored into the pixel array according to the display times.

The controller may include; a data memory device configured to store the received video data; a sub-frame data generator configured to generate the M sub-frame gray data based on the stored video data; and a timing controller configured to generate the sub-frame synchronization signal based on the received video synchronization signal.

The data driver may include: a latch circuit configured to receive the M sub-frame gray data in units of rows; a digital-to-analog converter (DAC) configured to convert the received M sub-frame gray data into the M sub-frame gray signals; and an output buffer configured to provide the M sub-frame gray signals to the pixel array. The output buffer may sequentially provide the first through M-th sub-frame gray signals to the pixel array. Alternatively, the output buffer may provide the first through M-th sub-frame gray signals to the pixel array in a reverse order.

The display time corresponding to the K-th sub-frame gray signal may be proportional to N^{K}, where K is an integer no less than one and not greater than M. For example, the integer N may correspond to 2^{L}, where L is an integer no less than two.

In exemplary embodiments of the present invention, a method for displaying an image includes: receiving video data; generating M sub-frame gray signals based on the received video data, each of the M sub-frame gray signals having N gray levels, in which the M sub-frame gray signals include first through M-th sub-frame gray signals, M being an integer no less than two, N being an integer no less three; and displaying M sub-frame images based on the M sub-frame gray signals according to display times to display the image, the display times respectively corresponding to each of the M sub-frame gray signals and being different from each other.

The display time corresponding to the K-th sub-frame gray signal may be proportional to N^{K}, where K is an integer no less than one and not greater than M. The M sub-frame images may be displayed by sequentially providing the first through M-th sub-frame gray signals to a pixel array. Alternatively, the M sub-frame images may be displayed by providing the first through M-th sub-frame gray signals to a pixel array in a reverse order.

The integer N may correspond to 2^{L}, where L is an integer no less than two.

In exemplary embodiments of the present invention, an apparatus for displaying an image includes: means for receiving video data; means for generating M sub-frame gray signals based on the received video data, each of the M sub-frame gray signals having N gray levels, in which the N sub-frame gray signals include first through M-th sub-frame gray signals, M being an integer no less than two, N being an integer no less than three; and means for displaying M sub-frame images based on the M sub-frame gray signals according to display times to display the image, the display times respectively corresponding to each of the M sub-frame gray signals and being different from each other.

The display time corresponding to the K-th sub-frame gray signal of the M sub-frame gray signals may be proportional to N^{K}, where K is an integer no less than one and not greater than M. The means for displaying the M sub-frame images may display the M sub-frame images by sequentially providing the first through M-th sub-frame gray signals to a pixel array. Alternatively, the means for displaying the M sub-frame images may display the M sub-frame images by providing the first through M-th sub-frame gray signals to a pixel array in a reverse order.

The integer N may correspond to 2^{L}, where L is an integer, no less than two.

In exemplary embodiments of the present invention, an apparatus for displaying an image includes: a pixel array; a controller configured to generate M sub-frame gray data based on received video data, each of the M sub-frame gray signals having N gray levels, M being an integer no less than two, N being an integer no less than three; a data driver configured to convert the M sub-frame gray data into M sub-frame gray signals, and configured to provide the M sub-frame gray signals to a pixel array according to display times, in which the M sub-frame gray signals include first through M-th sub-frame gray signals, the display times respectively corresponding to each of the M sub-frame gray signals and being different from each other; and a gate driver configured to provide scan signals to the pixel array in response to the sub-frame synchronization signal so that the M sub-frame gray signals are sequentially stored into the pixel array according to the display times.

The controller may include: a data memory device configured to store the received video data; a sub-frame data generator configured to generate the M sub-frame gray data based on the stored video data; and a timing controller configured to generate a sub-frame synchronization signal based on a received video synchronization signal.

The data driver may include: a latch circuit configured to receive the M sub-frame gray data in units of rows; a digital-to-analog converter (DAC) configured to convert the received M sub-frame gray data into the M sub-frame gray signals; and an output buffer configured to provide the M sub-frame gray signals to the pixel array. The output buffer may sequentially provide the first through M-th sub-frame gray signals to the pixel array. Alternatively, the output buffer may provide the first through M-th sub-frame gray signals to the pixel array in a reverse order.

The display time that may correspond to the K-th sub-frame gray signal is proportional, to N^{K}, where K is a integer no less than one and not greater than M. The integer N may correspond to 2^{L}, where L is an integer no less than two.

The pixel array may include an active matrix organic light-emitting diode (OLED).

Therefore, the display method and the display device may represent the gray levels with a reduced number of sub-frames.

### BRIEF DESCRIPTION OF THE DRAWINGS

Exemplary embodiments of the present invention will be understood in more detail to from the following descriptions taken in conjunction with the accompanying drawings.

FIG. 1 is a circuit diagram illustrating a pixel structure of an organic light-emitting diode (OLED) device that is driven by a conventional time ratio gray (TRG) method.

FIG. 2 is a diagram for describing a conventional TRG method of displaying 16 gray levels.

FIG. 3 is a circuit diagram illustrating a pixel structure that is driven by a conventional area ratio gray (ARG) method.

FIG. 4 is a block diagram illustrating a display device according to an exemplary embodiment of the present invention.

FIG. 5 is a block diagram illustrating a configuration of a data driver shown in FIG. 4.

FIG. 6 is a block diagram illustrating a configuration of a gate driver shown in FIG. 4.

FIG. 7 is a block diagram illustrating a configuration of a controller shown in FIG. 4.

FIG. 8 is a circuit diagram illustrating a structure of a pixel included in the pixel array shown in FIG. 4.

FIG. 9 is a diagram for use in describing a method of driving a display device according to an exemplary embodiment of the present invention.

FIG. 10 is a diagram for describing a method of driving a display device according to an exemplary embodiment of the present invention.

FIGS. 11 and 12 are graphs illustrating I-V curves of a thin-film transistor used an an amorphous silicon panel.

FIGS. 13 through 16 are tables illustrating various sub-frame gray data generated based on 8-bit data.

FIG. 17 is a table illustrating a method of representing video data as first through M-th sub-frame gray data.

FIG. 18 is a flow chart illustrating a method of driving a display device using the sub-frame gray signal according to an exemplary embodiment of the present invention.

### DETAILED DESCRIPTION OF EXEMPLARY EMBODIMENTS

Detailed illustrative exemplary embodiments of the present invention are disclosed herein. Specific structural and functional details disclosed herein, however, are merely representative for purposes of describing the exemplary embodiments of the present invention. This invention may, however, be embodied in may alternative forms and should not be construed as limited to the exemplary embodiments of the present invention set forth herein.

Accordingly, while the invention is susceptible to various modifications and alternative forms, exemplary embodiments thereof shown by way of example in the drawings and will herein be described in detail. It should be understood, however, that there is no intent to limit the invention to the particular forms disclosed, but on the contrary the invention is to cover all modifications equivalents, and alternatives falling within the spirit and scope of the invention. Like numbers refer to like elements throughout the description of the figures.

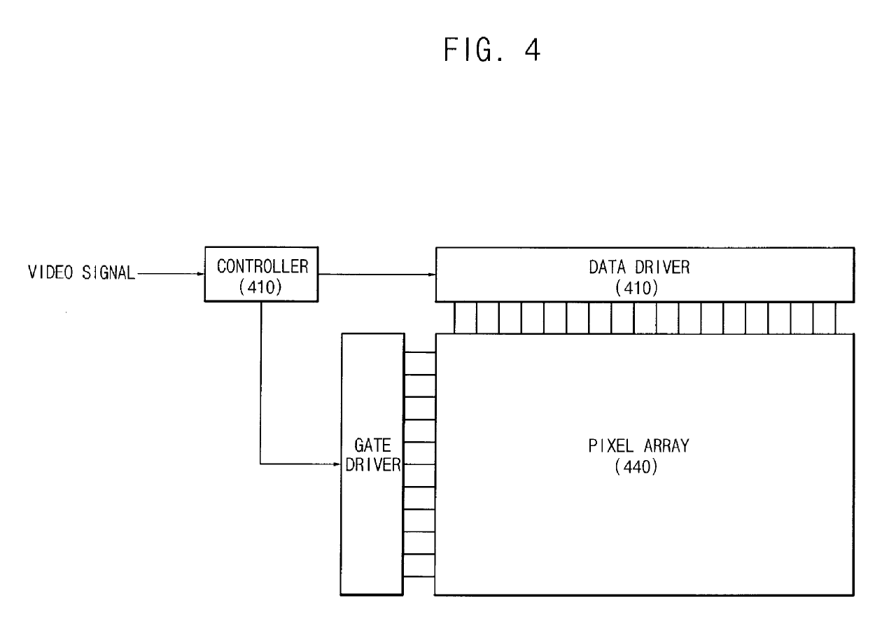

FIG. 4 is a block diagram illustrating a display device according to according to an exemplary embodiment of the present invention.

Referring to FIG. 4, the display device 400 may be divided into a display panel and a display driving device. The display driving device includes a controller 410, a data driver 420, and a gate driver 430. The display panel includes a pixel array 440, which may further include some elements of the data driver 420 and the gate driver 400.

The controller 410 receives a video signal from a host device (not shown). The video signal includes video data that is, pixel data, and a video synchronization signal. The controller 410 generates sub-frame gray data corresponding to the received video signal and a sub-frame synchronization signal.

For example, when the pixel array 440 includes M×N pixels, the controller 410 generates respective M (M is greater or equal to a value of 2) sub-frame gray data for each of the M×N pixels to display a video image having a size of M×N. The generated M sub-frame gray data are provided to the data driver 420.

The data driver 420 may be referred to as a column driver and receives M sub-frame gray data from the controller 410 to generate M sub-frame gray signals.

The gate drive 430 provides scan signals so that transmitted M sub-frame gray signals may be sequentially stored to the pixel array 410 in response to the sub-frame synchronization signal.

The pixel array 440 includes a plurality of pixels. In an exemplary embodiment, each of the pixels may include an organic light-emitting diode (OLED). In another exemplary embodiment, however, each of the pixels may include liquid crystal material.

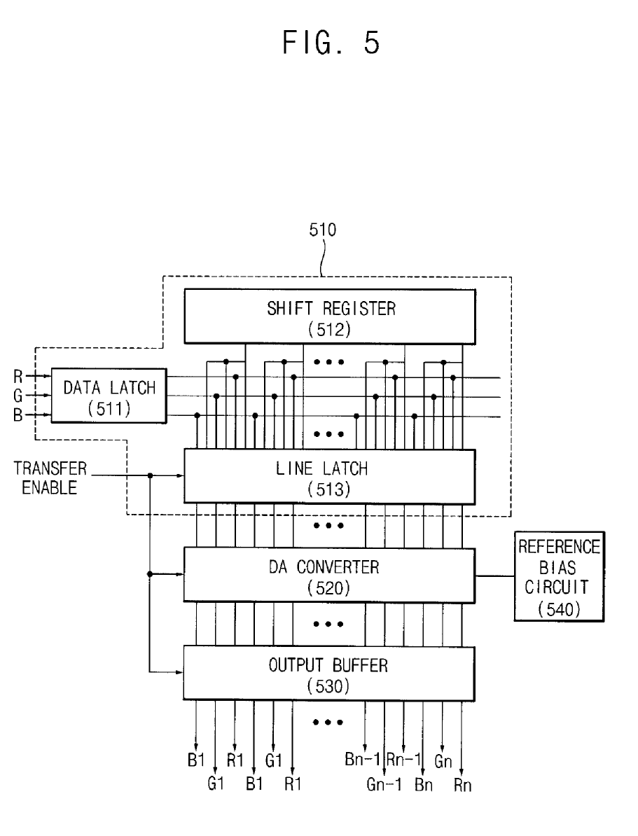

FIG. 5 is a block diagram illustrating a configuration of the data driver 420 shown in FIG. 4.

Referring to FIG. 5, the data driver 420 includes a latch circuit 510, a digital-to-analog converter (DAC) 520 and an output buffer 530.

The latch circuit 510 may include a data latch 511, a shift register 512 and a line latch 513, and receives sub-frame gray data row by row. The sub-frame gray data has N (N is an integer no less than three) gray levels. For example, the sub-frame gray data may have 2^{L} (L is an integer no less than two) gray levels. The sub-frame gray data corresponding to a pixel may be represented as a red-green-blue (RGB) data such that a red data, a green data and a blue data respectively have an L bit.

The data latch 511 provides the sub-frame gray, data to the line latch 513. The shift register 512 sequentially provides a latch enable signal to the line latch 513, from a first line to an n-th line. The line latch 513 provides the sub-frame gray data, to the DAC 520, by a unit of a row.

The DAC 520 changes the sub-frame gray data into a sub-frame gray signal according to a reference bias voltage or a reference bias current. The reference bias voltage or current may be a gamma corrected voltage or a gamma corrected current.

The output buffer 530 provides the sub-frame gray signal to the pixel array 440 according to the scan signal of the gate driver 430 shown in FIG. 4.

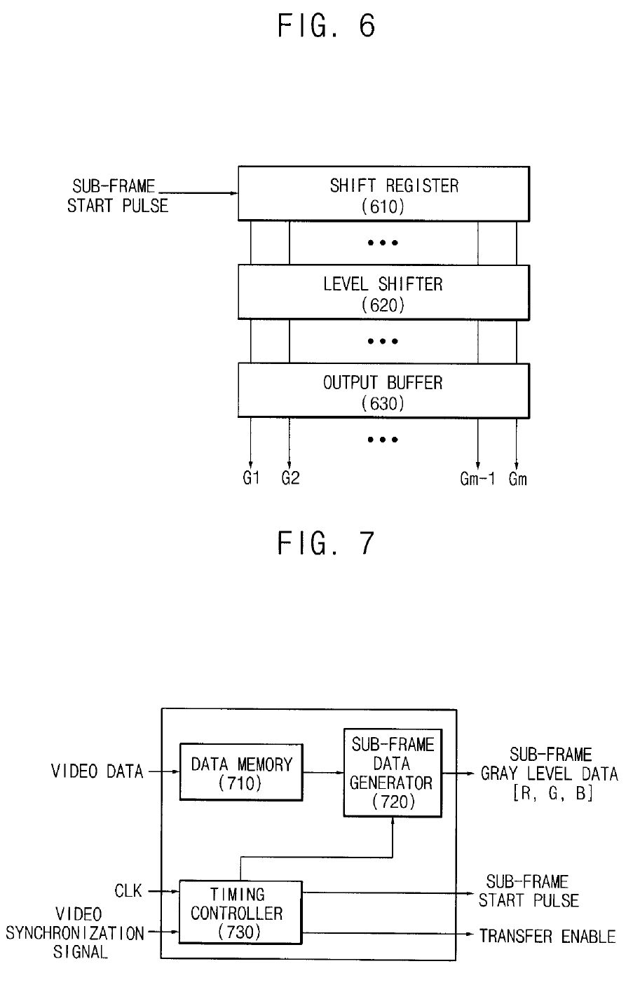

FIG. 6 is a block diagram illustrating a configuration of the gate driver 430 shown in FIG. 4.

Referring to FIG. 6, the gate driver 430 includes a shift register 610, a level shifter 620 and an output buffer 630.

The gate driver 430 provides scan signals to the pixel array 440 in response to the sub-frame synchronization signal. The sub-frame synchronization signal may be provided to the gate driver 430 as a form of a sub-frame start pulse. The gate driver 440 uses the sub-frame start pulse to generate the scan signals.

More specifically, the shift register 610 receives the sub-frame start pulse and performs a shift operation on the sub-frame start pulse to sequentially output the scan data for a first gate line to an m-th gate line.

The level shifter 620 performs a level shift operation on the scan data to generate a voltage sufficient to drive the scan line of the pixel array 440 and outputs the level-shifted scan signals.

The output buffer 630 provides the scan signals to the pixel array 440.

FIG. 7 is a block diagram illustrating a configuration of the controller 410 shown in FIG. 4.

Referring to FIG. 7, the controller 410 includes a data memory device 710, a sub-frame data generator 720 and a timing controller 730.

The data memory device 710 receives video data included in a video signal and stores the received video data. The sub-frame data generator 720 generates a first through M-th sub-frame gray data based on the stored video data. The timing controller 730 receives the video synchronization signal to generate the sub-frame synchronization signal.

The video data stored in the data memory device 710 may be video data of the RGB format. For example, when the video data for representing a single pixel corresponds to 24 bits of RGB format, each of the R, G and B data may correspond to eight bits. The video data is not limited to the RGB format, and video data of other formats, for example, video data of YCbCr format may be stored in the data memory device 710.

The sub-frame data generator 720 generates M (M is an integer no less than two) sub-frame gray data based on single video data. Each of the sub-frame gray data has N (N is an integer no less than three) gray levels. For example, a sub-frame gray data size corresponds to L bits and thus 2^{L} gray levels may be represented by each of the sub-frame gray data.

For example, when M is equal to a value of four, the sub-frame data generator 790 generates first through fourth sub-frame gray data based on the video data for the single pixel. When the R data corresponds to a value of “11001001”, the first sub-frame gray data correspond to a value of ‘11’, the second sub-frame gay data may correspond to a value of ‘00’, the third sub-frame gray data may correspond to a value of ‘10’, and the fourth sub-frame gray data may correspond to a value of ‘01’. In this case, each of the sub-frame gray data has four gray levels, and a ratio of light-emitting times respectively corresponding to the first through fourth sub-frame gray data may be 64:16:4:1.

As another example, where M is equal to a value of two, the sub-frame data generator 720 generates first and second sub-frame gray data based on the video data for a single pixel. When the R data corresponds to a value of ‘11001001’, the first sub-frame gray data may correspond to a value of ‘1100’ and the second sub-frame gray data may correspond to a value of ‘1001’. In this case, each of the sub-frame gray data has sixteen gray levels, and a ratio of light-emitting times respectively corresponding to the first through second sub-frame gray data may be 16:1. In the same way, the G data and the B data may be generated.

The timing controller 730 receives a video synchronization signal such as a vertical synchronization signal, a horizontal synchronization signal, or a dot clock, and generates the sub-frame synchronization signals, such as a sub-frame start pulse and a transferrable signal based on the received video synchronization signal.

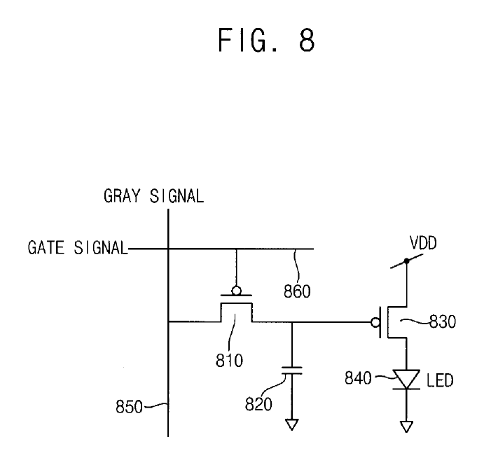

FIG. 8 is a circuit diagram illustrating a structure of a pixel included in the pixel array 440 shown in FIG. 4.

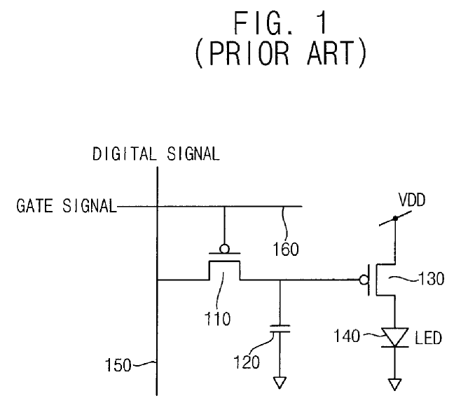

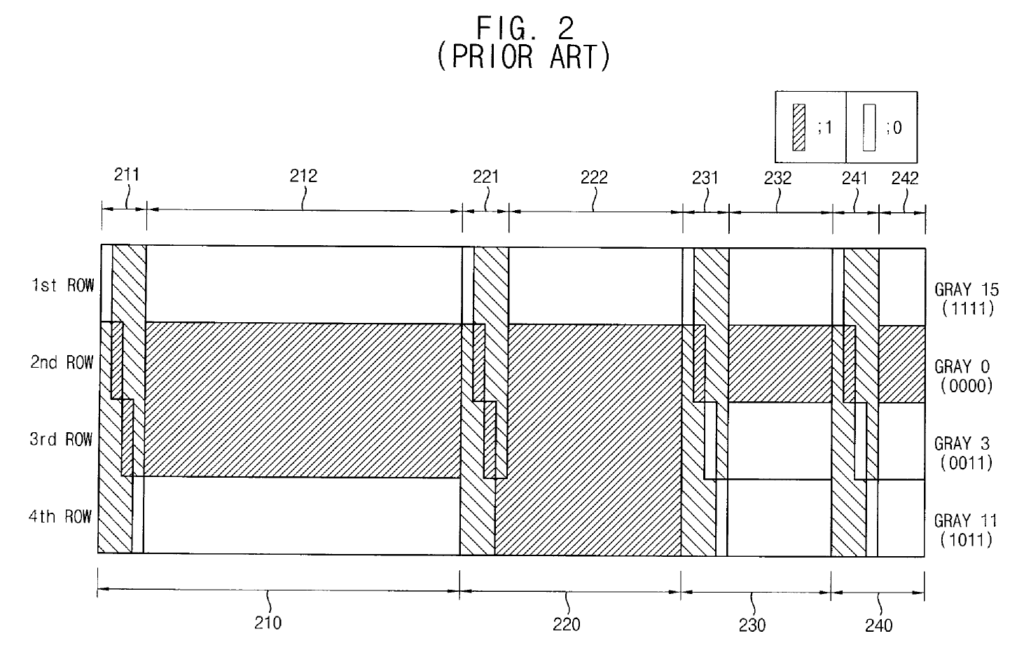

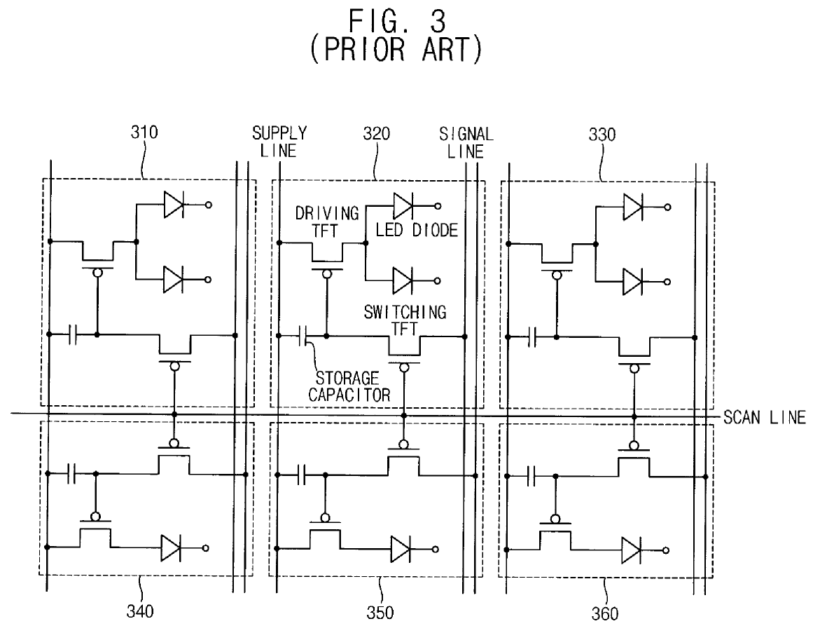

Referring to FIG. 8, the pixel 800 includes a switch transistor 810, a cell capacitor 820, a driving transistor 830 and an LED 840. The configuration of the pixel may be variously changed, and the same configuration of FIG. 1 is illustrated in FIG. 8 only as an example.

A gate of the switch transistor 810 is coupled to a scan line 860. The switch transistor 810 is turned on or turned off according to a gate signal transmitted through the scan line 860. When the switch transistor 810 is turned on, the sub-frame gray signal is transmitted, through a data line 850, to the cell capacitor 820. The sub-frame gray signal may have at least three gray levels, whereas a signal transmitted to the cell capacitor 120 in FIG. 1 has two gray levels.

A gate of the driving transistor 830 is coupled to one terminal of the cell capacitor 820. An amount of current outputted from the driving transistor 830 may vary according to a voltage of the cell capacitor 820. A light intensity of the LED 840 is increased when the amount of the current outputted from the driving transistor 830 is increased, and the light intensity of the LED 840 is decreased when the amount of the current outputted from the driving transistor 830 is decreased.

The LED 840 may be an OLED including a light-emitting polymer and emitting light in proportion to the amount of the current flowing through the OLED. As described above, the number of gray levels that a pixel may represent is greater than or equal to three. In addition, the TRG method may be used together with the no less than three gray levels so as to represent more varied gray levels.

The method of dividing the video data into the sub-frame gray data may be implemented in a pixel array with an active matrix OLED type as shown in FIG. 8, and the same method may also be implemented in an LCD device including a backlight and liquid crystal.

Hereinafter, a method of driving a display device by dividing the video data into sub-frame gray data will be described.

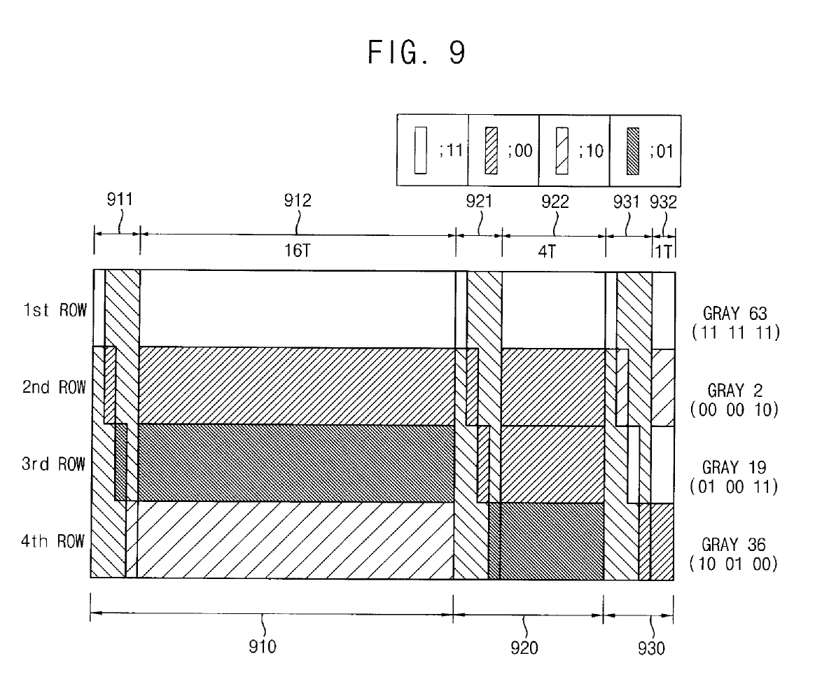

In FIGS. 9 through 12, the number of gray levels of the sub-frame gray signal is assumed to be four.

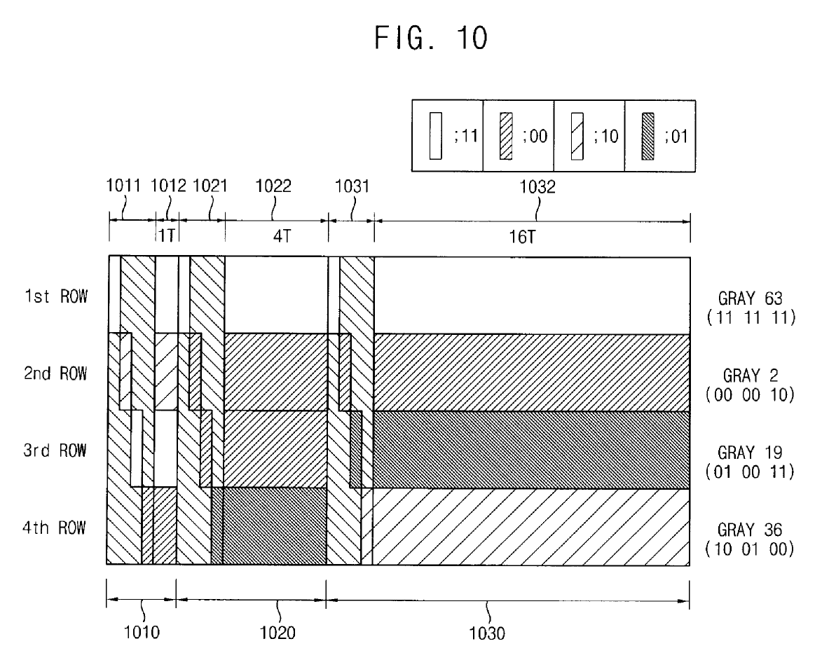

FIGS. 9 and 10 are diagrams for use in describing a method of driving a display device according to exemplary embodiments of the present invention.

As illustrated in FIG. 9, 6-bit video data representing 64 gray levels may be displayed with three sub-frame gray signals. FIG. 9 illustrates a method of driving four pixels that are coupled to the same data line and respectively coupled to different scan lines.

First video data provided to the first pixel corresponds to a value of ‘111111’. Second video data provided to the second pixel corresponds to a value of ‘000010’. Third video data provided to the third pixel corresponds to a value of ‘010011’. Fourth video data provided to the fourth pixel corresponds to a value of ‘100100’.

First through third sub-frame gray data of the first video data all correspond to a value of ‘11’. First through third sub-frame gray data of the second video data respectively correspond to values of ‘00’, ‘00’ and ‘10’. First through third sub-frame gray data of the third video data respectively correspond to values of ‘01’, ‘00’ and ‘11’. First through third sub-frame gray data of data fourth video data respectively correspond to values of ‘10’, ‘01’ and ‘00’.

FIG. 9, the first through third sub-frame gray signals may be sequentially provided to the pixel array. A first period 910 is for the first sub-frame gray signal, a second period 920 is for the second sub-frame gray signal, and a third period 930 is for the third sub-frame gray signal. The first through third periods 910, 920 and 930 include addressing periods 911, 921 and 931, and light-emitting periods 912, 922 and 932, respectively.

A procedure involving the addressing periods 911, 921 and 931 may be controlled by a sub-frame start pulse.

More specifically, the procedure of the first period 910 begins when the sub-frame start pulse is provided to the gate driver 430 of FIG. 4. The gate driver 430 receives the sub-frame start pulse, and provides a first row scan signal to the pixel array. When the first row scan signal is provided, the first sub-frame gray signal of the first pixel, which corresponds to a value of ‘11’, is stored into a first pixel storage capacitor. After the first sub-frame gray signal of the first pixel is stored the first row scan signal is changed into a disabled state.

After the first row scan signal for the first pixel is provided, a second scan signal for the second pixel is provided, by the gate driver 430, to the pixel array. When the second row scan signal is provided, the second sub-frame gray signal of the second pixel, which corresponds to a value of ‘00’, is stored into a second pixel storage capacitor. After the second sub-frame gray signal of the second pixel is stored, the second row scan signal is changed into a disabled state.

After the second row scan signal for the second pixel is provided, a third scan signal for the third pixel is provided, by the gate driver 430, to the pixel array. When the third row scan signal is provided, the first sub-frame gray signal of the third pixel, which corresponds to a value of ‘01’, is stored into a third pixel storage capacitor. After the first sub-frame gray signal of the third pixel is stored, the third row scan signal is changed into a disabled state.

After the third row scan signal for the third pixel is provided, a fourth scan signal for the fourth pixel is provided, by the gate driver 430, to pixel array. When the fourth row scan signal is provided, the first sub-frame gray signal of the fourth pixel, which corresponds to a value of ‘10’, is stored into a fourth pixel storage capacitor. After the first sub-frame gray signal of the fourth pixel is stored, the fourth row scan signal is changed into a disabled state.

After a procedure of the first addressing period 911, a procedure of a first light-emitting period 912 begins.

The first through fourth pixels respectively emit light during a time period 16T with brightness levels corresponding to the gray signals respectively having values of ‘11’, ‘00’, ‘01’ and ‘10’.

In the exemplary embodiment of FIG. 9, the procedure of the first light-emitting period 912 may begin and end concurrently with respect to the first through fourth pixels. Other cases, however, are also possible. For example, the first pixel may emit light after addressing the first pixel is completed, although the fourth row scan signal for the fourth pixel is not vet provided. Also, the second pixel may emit light after addressing the second pixel is completed, although the fourth row scan signal for the fourth pixel is not yet provided. The first through fourth pixels respectively emit light during the fixed time period with brightness levels corresponding to gray signals respectively having values of ‘11’, ‘00’, ‘01’ and ‘10’. Therefore, the light-emitting period of the first row may be ended earlier than the light-emitting period of the fourth row.

When a procedure of the first period 910 is ended, the sub-frame start pulse is provided to the gate driver 430 again, and the procedure of the second period 920 begins.

The gate driver 430 receives the sub-frame start pulse, and provides a first row scan signal to the pixel array. When the first row scan signal is provided, the second sub-frame gray signal of the first pixel, which corresponds to a value of ‘11’, is stored into a first pixel storage capacitor. After the second sub-frame array signal of the first pixel is stored, the first row scan signal is changed into a disabled state.

After the first row scan signal for the first pixel is provided a second scan signal for the second pixel is provided, by the gate driver 430, to the pixel array. When the second row scan signal is provided, the second sub-frame gray signal of the second pixel, which corresponds to a value of ‘00’, is stored into a second pixel storage capacitor. After the second sub-frame gray signal of the second pixel is stored, the second row scan signal is changed into a disabled state.

After the second row scan signal for the second pixel is provided, a third scan signal for the third pixel is provided, by the gate driver 430, to the pixel array. When the third row scan signal is provided, the third sub-frame gray signal of the third pixel, which corresponds to a value of ‘00’, is stored into a third pixel storage capacitor. After the third sub-frame gray signal of the third pixel is stored, the third row scan signal is changed into a disabled state.

After the third row scan signal for the third pixel is provided, a fourth scan signal for the fourth pixel is provided, by the gate driver 430, to the pixel array. When the fourth row scan signal is provided, the fourth sub-frame gray signal of the fourth pixel, which corresponds to a value of ‘01’, is stored into a fourth pixel storage capacitor. After the fourth sub-frame gray of the fourth pixel is stored, the fourth row scan signal is changed into a disabled state.

After a procedure of the second addressing period 921, a procedure of a second light-emitting period 922 begins.

The first through fourth pixels respectively emit light during a time period 4T with brightness levels corresponding to gray signals respectively having values of ‘11’, ‘00’, ‘00’ and ‘01’.

When a procedure of the second period 920 is ended, the sub-frame start pulse is provided to the gate driver 430 again, and a procedure of the third period 930 begins.

The gate driver 430 receives the sub-frame start pulse, and provides a first row scan signal to the pixel array. When the first row scan signal is provided, the third sub-frame gray signal of the first pixel, which corresponds to a value of ‘11’, is stored into a first pixel storage capacitor. After the third sub-frame gray, signal of the first pixel is stored, the first row scan signal is changed into a disabled state.

After the first row scan signal for the first pixel is provided, a second scan signal for the second pixel is provided, by the gate driver 430, to the pixel array. When the second row scan signal is provided, the third sub-frame gray signal of the second pixel, which corresponds to a value of ‘10’, is stored into a second pixel storage capacitor. After the third sub-frame gray signal of the second pixel is stored, the third row scan signal is changed into a disabled state.

After the second row scan signal for the second pixel is provided, a third scan signal for the third pixel is provided, by the gate driver 430, to the pixel array. When the third row scan signal is provided, the third sub-frame gray signal of the third pixel, which corresponds to a value of ‘10’, is stored into a third pixel storage capacitor. After the third sub-frame gray signal of the third pixel is stored, the third row scan signal is changed into a disabled state.

After the third row scan signal for the third pixel is provided a fourth scan signal for the fourth pixel is provided, by the gate driver 430, to the pixel array. When the fourth row scan signal is provided, the fourth sub-frame gray signal of the fourth pixel, which corresponds to a value ‘01’, is stored into a fourth pixel storage capacitor. After the fourth sub-frame gray signal of the fourth pixel is stored, the fourth row scan signal is charged into a disabled state.

After a procedure of the third addressing period 931, a procedure of a third light-emitting period 932 begins.

The first through fourth pixels respectively emit light during a time period 1T with brightness levels corresponding to gray signals respectively having values of ‘11’, ‘10’, ‘11’ and ‘00’.

As described in the above procedures of the first through third periods 910, 920 and 930, the first through fourth pixels are sequentially caused to emit light by the first through third sub-frame gray signals, but the order of emitting light may be changed.

Referring to FIG. 10, in procedures of the first through third periods 1010, 1020 and 1030, the first through fourth pixels emit light in a reverse order by each of the first through third sub-frame gray signals. Namely, in the procedure of the first period 1010, the first through the fourth pixels are caused to emit light during a time period 1T by the third sub-frame gray signal. In the procedure of the second period 1020, the first through the fourth pixels are caused to emit light during a time period 4T by the second sub-frame gray signal. In the procedure of the third period 1030, the first through the fourth pixels are caused to emit light during a time period 16T by the first sub-frame gray signal.

In FIG 10, it is assumed that first video data corresponds to a value of ‘111111’, second video data corresponds to a value of ‘000010’, third video data corresponds to a value of ‘010011’, and fourth video data corresponds to a value of ‘100100’.

First through third sub-frame gray data of the first video data all correspond to a value of ‘11’. First through third sub-frame gray data of the second video data respectively correspond to values of ‘00’, ‘00’ and ‘10’. First through third sub-frame gray data of the third video data respectively correspond to values of ‘01’, ‘00’ and ‘11’. First through third sub-frame gray data of the fourth video data respectively correspond to values of ‘10’, ‘10’ and ‘00’.

Each of the first through third periods 1010, 1020 and 1030 includes addressing periods 1011, 1021 and 1031, and light-emitting periods 1012, 1022 and 1032. In the first period 1010, the first through fourth pixels are caused to emit light by the third sub-frame gray signal. In the second period 1020, the first through fourth pixels are caused to emit light by the second sub-frame gray signal. In the third period 1030, the first through fourth pixels are caused to emit light by the first sub-frame gray signal.

A procedure of the addressing periods 1011, 1021 and 1031 is controlled by a respective sub-frame start pulse.

A procedure of the first period 1010 begins when the sub-frame start pulse is provided to the gate driver 430. The gate driver 430 receives the sub-frame start pulse, and provides a first row scan signal to the pixel array. When the first row scan signal is provided, the third sub-frame gray signal of the first pixel, which corresponds to a value of ‘11’, is stored into a first pixel storage capacitor. After the third sub-frame gray signal of the first pixel is stored, the first row scan signal is changed into a disabled state.

After the first row scan signal for the first pixel is provided, a second scan signal for the second pixel is provided, by the gate driver 430, to the pixel array. When the second row scan signal is provided the second sub-frame gray signal of the second pixel, which corresponds to a value of ‘10’, is stored into a second pixel storage capacitor. After the second sub-frame gray signal of the second pixel is stored, the second row scan signal is changed into a disabled state.

After the second row scan signal for the second pixel is provided, a third scan signal for the third pixel is provided, by the gate driver 430, to the pixel array. When the third row scan signal is provided, the third sub-frame gray signal of the third pixel, which corresponds to a value of ‘11’, is stored into a third pixel storage capacitor. After the third sub-frame gray signal of the third pixel is stored, the third row scan signal is changed into a disabled state.

After the third row scan signal for the third pixel is provided, a fourth scan signal for the fourth pixel is provided, by the gate driver 430, to the pixel array. When the fourth row scan signal is provided, the third sub-frame gray signal of the fourth pixel, which corresponds to a value of ‘00’, is stored into a fourth pixel storage capacitor. After the third sub-frame gray signal of the fourth pixel is stored, the fourth row scan signal is changed into a disabled state.

After a procedure of the first addressing period 911, a procedure of a first light-emitting period 912 begins.

The first through fourth pixels respectively emit light during a time period 1T with brightness levels corresponding to gray signals respectively having values of ‘11’, ‘10’, ‘11’ and ‘00’.

In the example of FIG. 10, the procedure of the first light-emitting period 1012 may begin and end concurrently at the first through fourth pixels, but other cases may be also possible. For example, the first pixel may emit light in a case where the first row scan signal for the first pixel is provided, although the fourth row scan signal for the fourth pixel is not provided. Also, the second pixel may emit light in a case where the second row scan signal for the second pixel is provided, although the fourth row scan signal for the fourth pixel is not provided.

When a procedure of the first period 1010 is ended, the sub-frame start pulse is provided to the gate driver 430 again, and a procedure of the second period 1020 begins.

The gate driver 430 receives the sub-frame start pulse, and provides a first row scan signal to the pixel array. When the first row scan signal is provided, the second sub-frame gray signal of the first pixel, which corresponds to a value of ‘11’, is stored into a first pixel storage capacitor. After the second sub-frame gray signal of the first pixel is stored, the first row scan signal is changed into a disabled state.

After the first row scan signal for the first pixel is provided a second scan signal for the second pixel is provided, by the gate driver 430, to the pixel array. When the second row scan signal is provided the second sub-frame gray signal of the second pixel, which corresponds to a value of ‘00’, is stored into a second pixel storage capacitor. After the second sub-frame gray signal of the second pixel is stored, the second row scan signal is changed into a disabled state.

After the second row scan signal for the second pixel is provided, a third scan signal for the third pixel is provided, by the gate driver 430, to the pixel array. When the third row scan signal is provided, the third sub-frame gray signal of the third pixel, which corresponds to a value of ‘00’, is stored into a third pixel storage capacitor. After the third sub-frame gray signal of the third pixel is stored, the third row scan signal is changed into a disabled state.

After the third row scan signal for the third pixel is provided, a fourth scan signal for the fourth pixel is provided, by the gate driver 430, to the pixel array. When the fourth row scan signal is provided, the third sub-frame gray signal of the fourth pixel, which corresponds to a value of ‘01’, is stored into a fourth pixel storage capacitor. After the third sub-frame gray signal of the fourth pixel is stored, the fourth row scan signal is changed into a disabled state.

After a procedure of the second addressing period 1021, a procedure of a second light-emitting period 1022 begins.

The first through fourth pixels respectively emit light during a time period 4T with brightness levels corresponding to gray signals which respectively have values of ‘11’, ‘00’, ‘00’ and ‘01’.

When a procedure of the second period 1020 is ended, the sub-frame start pulse is provided to the gate driver 430 again, and a procedure of the third period 1030 begins.

The gate driver 430 receives the sub-frame start pulse, and provides a first row scan signal to the pixel array. When the first row scan signal is provided, the first sub-frame gray signal of the first pixel, which corresponds to a value of ‘11’, is stored into a first pixel storage capacitor. After the first sub-frame gray signal of the first pixel is stored, the first row scan signal is changed into a disabled state.

After the first row scan signal for the first pixel is provided, a second scan signal for the second pixel is provided, by the gate driver 430, to the pixel array. When the second row scan signal is provided, the third sub-frame gray signal of the second pixel, which corresponds to a value of ‘10’, is stored into a second pixel storage capacitor. After the third sub-frame gray signal of the second pixel is stored, the third row scan signal is changed into a disabled state.

After the second row scan signal for the second pixel is provided, a third scan signal for the third pixel is provided, by the gate driver 430, to the pixel array. When the third row scan signal is provided, the first sub-frame gray signal of the third pixel, which corresponds to a value of ‘11’, is stored into a third pixel storage capacitor. After the first sub-frame gray, signal of the third pixel is stored, the third row scan signal is changed into a disabled state.

After the third row scan signal for the third pixel is provided, a fourth scan signal for the fourth pixel is provided, by the gate driver 430, to the pixel array. When the fourth row scan signal is provided, the first sub-frame gray signal of the fourth pixel, which corresponds to a value of ‘01’, is stored into a fourth pixel storage capacitor. After the first sub-frame gray signal of the fourth pixel is stored, the fourth row scan signal is changed into a disabled state.

After a procedure of the third addressing period 1031, a procedure of a third light-emitting period 1032 begins.

The first through fourth pixels respectively emit light during a time period 16T with brightness levels corresponding to gray signals respectively which have values of ‘11’, ‘10’, ‘11’ and ‘00’.

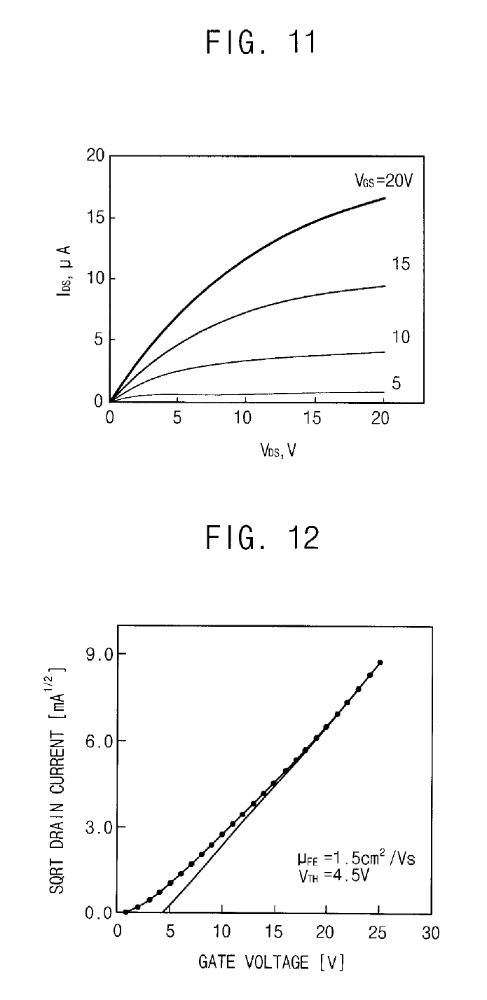

FIGS. 11 and 12 are graphs illustrating current-voltage (I-V) curves of a thin-film transistor used in an amorphous silicon panel.

Referring to FIG. 11, a voltage between a gate and a source of the driving transistor 830 of FIG. 8 may be set to 5 V, 10 V, 15 V and 20 V in order to control an amount of a current flowing to the OLED 840 with four different levels. The data driver 420 provides the sub-frame gray signals having corresponding voltages to the cell capacitor 820 in order to respectively set the voltage between the gate of the driving transistor 830 and the source of the driving transistor 830 as 5 V, 10 V, 15 V and 20 V. That is, the voltage between the gate of the driving transistor 830 and the source of the driving transistor 830 is controlled by the voltage of the cell capacitor 820.

When the voltage between a drain of the driving transistor 830 and a source of the driving transistor 830 corresponds to 20 V, and the voltage of a gate of the driving transistor 830 and a source of the driving transistor 830 respectively corresponds to 5 V, 10 V, 15 V and 20 V, an amount of a current flowing to the OLED 840 respectively corresponds to 2 μA, 4 μA, 8 μA and 16 μA.

Referring to FIG. 12, a gate voltage of the driving transistor 830 is linearly proportional to a square root of a drain current of the driving transistor 830 when the gate voltage of the driving transistor 830 is larger than a threshold voltage. That is, an amount of a drain current is proportional to a square of the gate voltage.

Therefore, the amount of the current flowing to the OLED 840 may be controlled by controlling a voltage of the cell capacitor 820 coupled to a gate of the driving transistor 830, and thereby the brightness of the OLED 840 may be controlled.

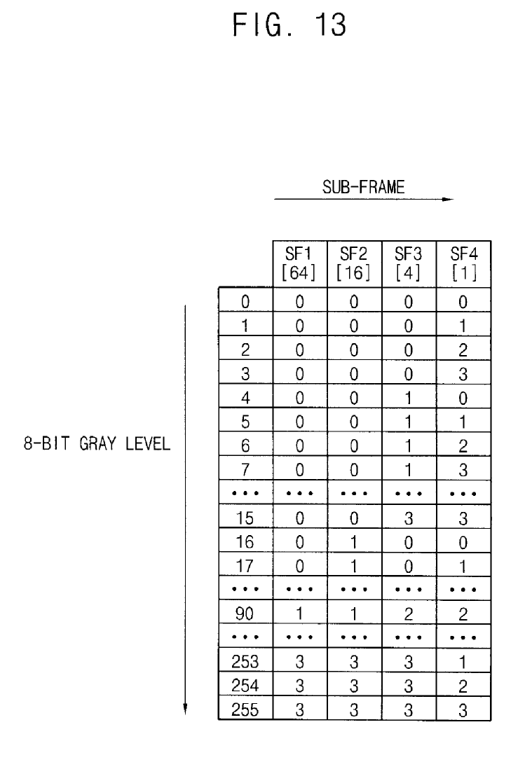

FIGS. 13 through 16 are tables illustrating various sub-frame gray data generated based on 8-bit data.

In FIG. 13, values of the sub-frame gray data are illustrated when single video data is represented by using four sub-frames.

Each of the first through fourth sub-frame gray data has four gray levels. Therefore the first through fourth sub-frame gray data, are represented as two bits, and a ratio of periods of the first through fourth sub-frame gray data may be 64:16:4:1.

When the first sub-frame gray level corresponds to a value of 0, the video gray data represents a value of 0. When the first sub-frame gray level corresponds to a value of 1, the video gray data represents a value of 64. When the first sub-frame gray level corresponds to a value of 2, the video gray data represents a value of 128. When the first sub-frame gray level corresponds to a value of 3, the video gray data represents a value of 192.

When the second sub-frame gray level corresponds to a value of 0, the video gray data represents a value of 0. When the second sub-frame gray level corresponds to a value of 1, the video gray data represents a value of 16. When the second sub-frame gray level corresponds to a value of 2, the video gray data represents a value of 32. When the second sub-frame gray level corresponds to a value of 3, the video gray data represents a value of 48.

When the third sub-frame gray level corresponds to a value of 0, the video gray data represents a value of 0. When the third sub-frame gray level corresponds to a value of 1, the video gray data represents a value of 4. When the third sub-frame gray level corresponds to a value of 2, the video gray data represents a value of 8. When the third sub-frame gray level corresponds to a value of 3, the video gray data, represents a value of 12.

When the fourth sub-frame gray level corresponds to a value of 0, the video gray data represents a value of 0. When the fourth sub-frame gray level corresponds to a value of 1, the video gray data represents a value of 1. When the third sub-frame gray level corresponds to a value of 2, the video gray data represents a value of 2. When the third sub-frame gray level corresponds to a value of 3 the video gray data represents a value of 3.

For example, when the video gray data corresponds to a value of 90, the video gray data may be represented as the first sub-frame gray data of which a sub-frame gray level corresponds to a value of 1, the second sub-frame gray data of which a sub-frame gray level corresponds to a value of 1, the third sub-frame gray data of which a sub-frame gray level corresponds to a value of 2 and the fourth sub-frame gray data of which a sub-frame gray level corresponds to a value of 2.

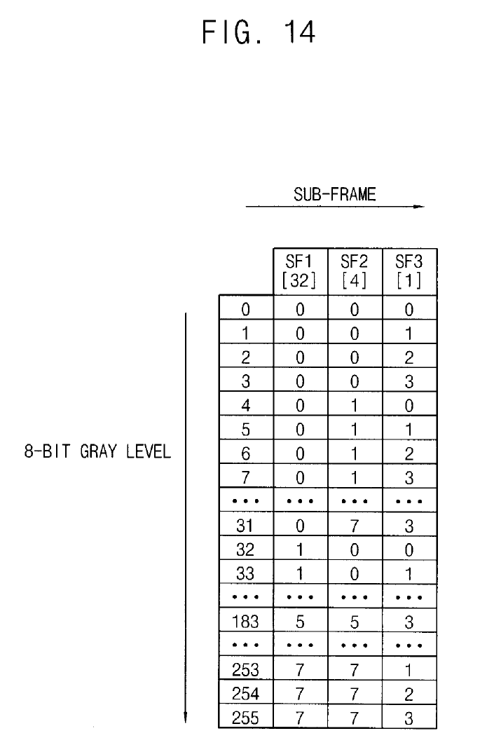

In FIG. 14 a value of the sub-frame gray data is illustrated when single video data is represented by using three sub-frames.

Each of the first and second sub-frame gray data has eight gray levels, and the third sub-frame gray data has four gray levels. Therefore, the first and second sub-frame gray data may be represented as three bits, and the third sub-frame gray data may be represented as two bits. Periods of the first through third sub-frame gray data correspond to a ratio of 32:4:1.

When the first sub-frame gray level corresponds to a value of 0, the video gray data represents a value of 0. When the first sub-frame gray level corresponds to a value of 1, the video gray data represents a value of 32. When the first sub-frame gray level corresponds to a value of 2, the video gray data represents a value of 64. When the first sub-frame gray level corresponds to a value of 3, the video gray data represents a value of 96. When the first sub-frame gray level corresponds to a value of 4, the video gray data represents a value of 128. When the first sub-frame gray level corresponds to a value of 5, the video gray data represents a value of 160. When the first sub-frame gray level corresponds to a value of 6, the video gray data represents a value of 192. When the first sub-frame gray level corresponds to a value of 7, the video gray data represents a value of 224.

When the second sub-frame gray level corresponds to a value of 0, the video gray data represents a value of 0. When the second sub-frame gray level corresponds to a value of 1, the video gray data represents a value of 4. When the second sub-frame gray level corresponds to a value of 2, the video gray data represents a value of 3. When the second sub-frame gray level corresponds to a value of 3, the video gray data represents a value of 12. When the second sub-frame gray level corresponds to a value of 4, the video gray data represents a value of 16. When the second sub-frame gray level corresponds to a value of 5, the video gray data represents a value of 20. When the second sub-frame gray level corresponds to a value of 6, the video gray data represents a value of 24. When the second sub-frame gray level corresponds to a value of 7, the video gray data represents a value of 28.

When the third sub-frame gray level corresponds to a value of 0, the video gray data represents a value of 0. When the third sub-frame gray level corresponds to a value of 1, the video gray data represents a value of 1. When the third sub-frame gray level corresponds to a value of 2, the video gray data represents a value of 2. When the third sub-frame gray level corresponds to a value of 3, the video gray data represents a value of 3. When the third sub-frame gray level corresponds to a value of 4, the video gray data represents a value of 4.

For example, when the video gray data corresponds to a value of 183, the video gray data may be represented as the first sub-frame gray data of which a sub-frame gray level corresponds to a value of 5, the second sub-frame gray data of which a sub-frame gray level corresponds to a value of 5, and the third sub-frame gray data of which a sub-frame gray level corresponds to a value of 3.

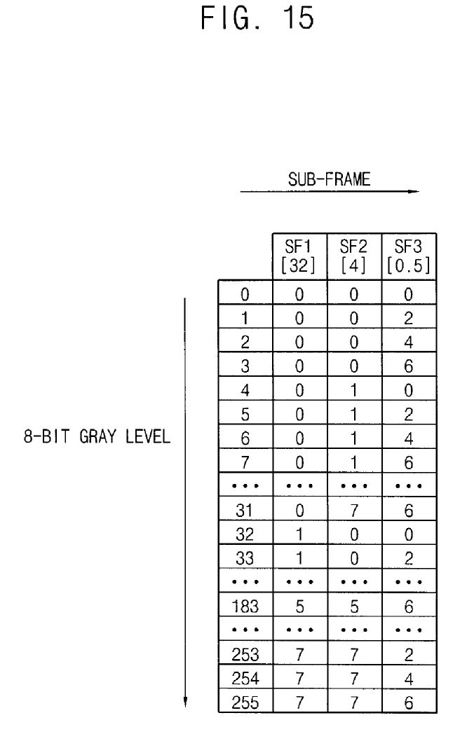

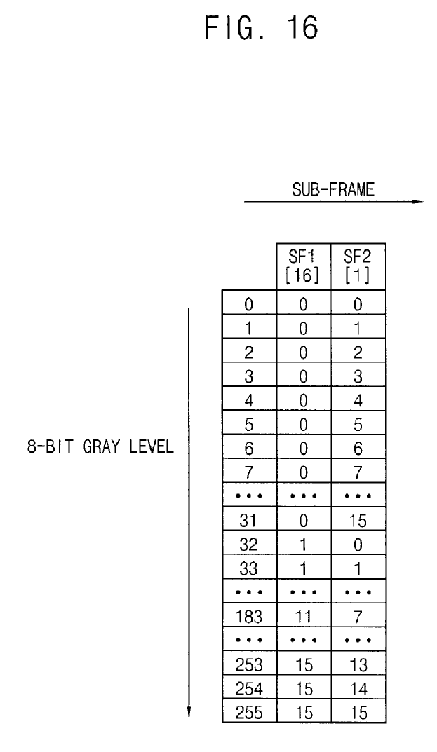

In FIG. 15, a value of the sub-frame gray data is illustrated when single video data is represented by using three sub-frames.

Each of the first through third sub-frame gray data has eight gray levels. Therefore, the first through third sub-frame gray data may be represented as three bits. Because the video gray data is configured with eight bits, however; the third sub-frame gray data may be configured with the least significant two bits of the video gray data and a single dummy bit. For example, the dummy bit may correspond to a value of 0. Periods of the first through third sub-frame gray data correspond to a ratio of 32:4:0.5.

When the first sub-frame gray level corresponds to a value of 0, the video gray data represents a value of 0. When the first sub-frame gray level corresponds to a value of 1, the video gray data represents a value of 32. When the first sub-frame gray level corresponds to a value of 2, the video gray data represents a value of 64. When the first sub-frame gray level corresponds to a value of 3, the video gray data represents a value of 96. When the first sub-frame gray level corresponds to a value of 4, the video gray data represents a value of 128. When the first sub-frame gray level corresponds to a value of 5, the video gray data represents a value of 160. When the first sub-frame gray level corresponds to a value of 6, the video gray data represents a value of 192. When the first sub-frame gray level corresponds to a value of 7, the video gray data represents a value of 224.

When the second sub-frame gray level corresponds to a value of 0, the video gray data represents a value of 0. When the second sub-frame gray level corresponds to a value of 1, the video gray data represents a value of 4. When the second sub-frame gray level corresponds to a value of 2, the video gray data represents a value of 8. When the second sub-frame gray level corresponds to a value of 3, the video gray data represents a value of 12. When the second sub-frame gray level corresponds to a value of 4, the video gray data represents a value of 16. When the second sub-frame gray level corresponds to a value of 5, the video gray data represents a value of 20. When the second sub-frame gray level corresponds to a value of 6, the video gray data represents a value of 24. When the second sub-frame gray level corresponds to a value of 7, the video gray data represents a value of 28.

When the third sub-frame gray level corresponds to a value of 0, the video gray data represents a value of 0. When the third sub-frame gray level corresponds to a value of 1, the video gray data represents a value of 2. When the third sub-frame gray level corresponds to a value of 2, the video gray data represents a value of 4. When the third sub-frame gray level corresponds to a value of 3, the video gray data represents a value of 6. When the third sub-frame gray level corresponds to a value of 4, the video gray data represents a value of 8.

For example, when the video gray data corresponds to a value of 183, the video gray data may be represented as the first sub-frame gray data of which a sub-frame gray level corresponds to a value of 5, the second sub-frame gray data of which a sub-frame gray level corresponds to a value of 5, and the third sub-frame gray data of which a sub-frame gray level corresponds to a value of 6.

In FIG. 16, a value of the sub-frame gray data is illustrated when single video data is represented by using two sub-frames.

Each of the first and second sub-frame gray data has four gray levels. Therefore, the first and second sub-frame gray data may be represented as four bits. A period of the first and second sub-frame gray data corresponds to a ratio of 16:1.

When the first sub-frame gray level corresponds to a value of 0, the video gray data represents a value of 0. When the first sub-frame gray level corresponds to a value of 1, the video gray data represents a value of 16. When the first sub-frame gray level corresponds to a value of 2, the video gray data represents a value of 32. When the first sub-frame gray level corresponds to a value of 3, the video gray data represents a value of 48. When the first sub-frame gray level corresponds to a value of 4, the video gray data represents a value of 64. When the first sub-frame gray level corresponds to a value of 5, the video gray data represents a value of 80. When the first sub-frame gray level corresponds to a value of 6, the video gray data represents a value of 96. When the first sub-frame gray level corresponds to a value of 7, the video gray data represents a value of 112. When the first sub-frame gray level corresponds to a value of 8, the video gray data represents a value of 128. When the first sub-frame gray level corresponds to a value of 9, the video gray data represents a value of 144. When the first sub-frame gray level corresponds to a value of 10, the video gray data represents a value of 160. When the first sub-frame gray level corresponds to a value of 11, the video gray data represents a value of 176. When the first sub-frame gray level corresponds to a value of 12, the video gray data represents a value of 192. When the first sub-frame gray level corresponds to a value of 13, the video gray data represents a value of 208. When the first sub-frame gray level corresponds to a value of 14, the video gray data represents a value of 244. When the first sub-frame gray level corresponds to a value of 15, the video gray data represents a value of 240.

When the second sub-frame gray level corresponds to a value of 0, the video gray data represents a value of 0. When the second sub-frame gray level corresponds to a value of 1, the video gray data represents a value of 1. When the second sub-frame gray level corresponds to a value of 2, the video gray data represents a value of 2. When the second sub-frame gray level corresponds to a value of 3, the video gray data represents a value of 3. When the second sub-frame gray level corresponds to a value of 4, the video gray data represents a value of 4. When the second sub-frame gray level corresponds to a value of 5, the video gray data represents a value of 5. When the second sub-frame gray level corresponds to a value of 6, the video gray data represents a value of 6. When the second sub-frame gray level corresponds to a value of 7, the video gray data represents a value of 7. When the second sub-frame gray level corresponds to a value of 8, the video gray data represents a value of 8. When the second sub-frame gray level corresponds to a value of 9. the video gray data represents a value of 9. When the second sub-frame gray level corresponds to a value of 10, the video gray data represents a value of 10. When the second sub-frame gray level corresponds to a value of 11, the video gray data represents a value of 11. When the second sub-frame gray level corresponds to a value of 12, the video gray data represents a value of 12. When the second sub-frame gray level corresponds to a value of 13, the video gray data represents a value of 13. When the second sub-frame gray level corresponds to a value of 14, the video gray data represents a value of 14. When the second sub-frame gray level corresponds to a value of 15, the video gray data represents a value of 15.

For example, when the video gray data corresponds to a value of 183, the video gray data may be represented as the first sub-frame gray data of which a sub-frame gray level corresponds to a value of 11, and the second sub-frame gray data of which a sub-frame gray level corresponds to a value of 7.

As described above, when the sub-frame gray data is configured with L (L is greater than or equal to a value of 2) bits, the number of the gray levels of the sub-frame gray data corresponds to a value of 2^{L}. However, other cases may also be possible, and for example, the number of the gray levels of the sub-frame data may correspond to N (N is greater than or equal to a value of 3).

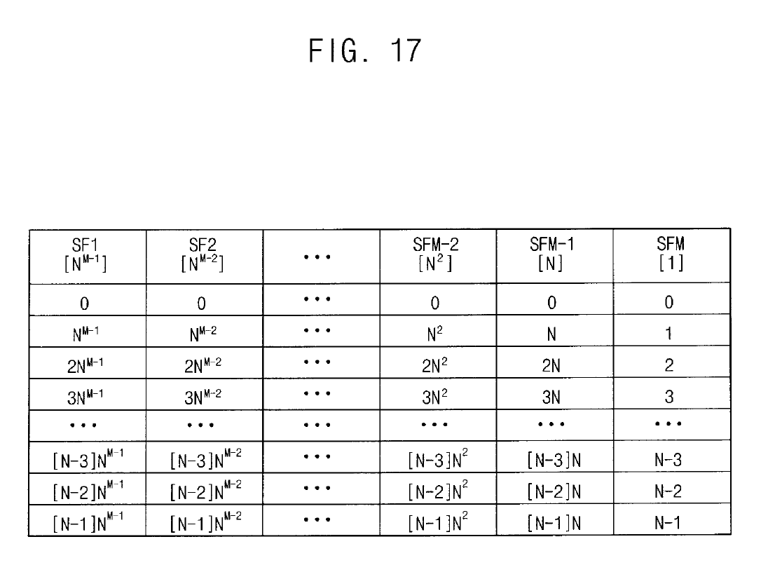

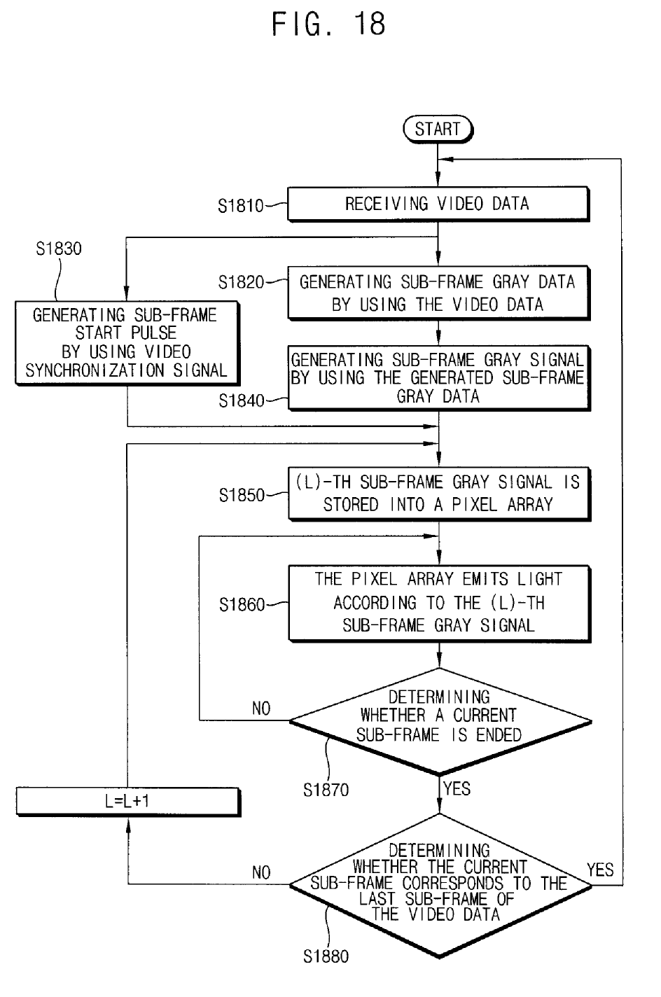

FIG. 17 is a table illustrating a method of representing video data as first through M-th sub-frame gray data.

In FIG. 17, the video data is represented as first through M-th sub-frame gray data, and the first sub-frame gray data may represent the video gray data corresponding to a value of N^{M-1}.

For example, when N corresponds to a value of 3 and M corresponds to a value of 2, the first sub-frame gray data may correspond to one of values of 0, 1 and 2, and each represents the video gray data corresponding to values of 0, 3 and 6.

As shown in FIG. 17, when the number of the gray levels does not correspond to a value of 2^{L} (L is greater than or equal to a value of 2), a mapping table may be required for mapping the video gray data into the sub-frame gray data.

FIG. 18 is a flow chart illustrating a method of driving a display device using the sub-frame gray signal according to an exemplary embodiment of the present invention.

The display device receives the video data (step S1810). The video data may have an RGB format, for example.

When the video data is received, the display device generates the sub-frame gray data by using the video data (step S1820), and generates the sub-frame gray signal by using the generated sub-frame gray data (step S1840). Meanwhile, the display device generates the sub-frame start pulse by using the video synchronization signal that is transmitted with the video data (step S1830). The sub-frame start pulse indicates a start time of the sub-frame.

After the sub-frame gray signal is generated, the first sub-frame gray signal is stored into the pixel array (step S1850).

The pixel array emits light according to the first sub-frame gray signal (step S1860). When emission of light is ended, the display device determines whether a current sub-frame is ended (step S1870). The current sub-frame is ended when the sub-frame start pulse of the next sub-frame is provided.

The displays device determines whether the current sub-frame corresponds to the last sub-frame of the video data (step S1880), and repeats steps S1850, S1860, S1870 and S1880 until the current sub-frame corresponds to the last sub-frame of the video data.

When the last sub-frame of the video data is ended, the display device returns to the step S1810.

Exemplary embodiments of the present invention being thus described, it will be obvious that the same may be varied in many ways. For example, a liquid crystal display (LCD) device may be implemented by adopting the method in which the video data is divided into sub-frame gray data for representing the gray levels.

As described above, a method of driving a display device according to above exemplary embodiments of the present invention includes digital characteristics and analog characteristics for representing gray levels. Therefore, the display device may represent the gray levels with a reduced number of sub-frames, and the display device is insensitive to a uniformity problem associated with a pixel location in a display panel and a stability problem associated with a change of characteristics of a pixel over time.

Additionally, the display device according to an exemplary embodiment of the present invention may reduce power consumption compared with the display device that is driven by the conventional TRG method.

While exemplary embodiments of the present invention and their advantages have been described in detail, it should be understood that various changes, substitutions and alterations may be made herein without departing from the scope of the invention.

What is claimed is:

1. A method for displaying an image, comprising:
receiving video data;
generating M sub-frame gray signals based on the received video data, each of the M sub-frame gray signals having N gray levels, the M sub-frame gray signals including first through M-th sub-frame gray signals, M being an integer no less than two, N being an integer no less than three; and
providing the M sub-frame gray signals to a pixel array according to display times to display the image, the display times respectively corresponding, to each of the M sub-frame gray signals and being different from each other.

2. The method of claim 1, wherein the display time corresponding to a K-th sub-frame gray signal is proportional to N^{K}, K being an integer no less than one and not greater than M.

3. The method of claim 2, wherein the step of providing the M sub-frame gray signals comprises sequentially providing the first through M-th sub-frame gray signals the pixel array.

4. The method of claim 2, wherein the step of providing the M sub-frame gray signals comprises providing the first through M-th sub-frame gray signals to the pixel array in a reverse order.

5. The method of claim 1, wherein the integer N corresponds to 2^{L}, L being an integer no less than two.

6. The method of claim 5, wherein the step of providing the M sub-frame gray signals comprises sequentially providing the first through M-th sub-frame gray signals to the pixel array.

7. The method of claim 5, wherein the step of providing the M sub-frame gray signals comprises providing the first through M-th sub-frame gray signals to the pixel array in a reverse order.

8. The method of claim 1, wherein a K-th sub-frame gray signal is stored into the pixel array after the display time corresponding to the (K−1)-th sub-frame gray signal elapses, K being an integer no less than two and not greater than M.

9. An apparatus for displaying an image, the apparatus comprising:
means for receiving video data;
means for generating M sub-frame gray signals based on the received video data, each of the M sub-frame gray signals having N gray levels, the M sub-frame gray signals including first through M-th sub-frame gray signals, M being an integer no less than two, N being an integer no less than three; and
means for providing the M sub-frame gray signals to a pixel array according to display times to display the image to display the image, the display times respectively corresponding to each of the M sub-frame gray signals and being different from each other.

10. The apparatus of claim 9, wherein the display time corresponding to a K-th sub-frame gray signal of the M sub-frame gray signals is proportional to N^{K}, K being an integer no less than one and not greater than M.

11. The apparatus of claim 10, wherein the means for providing the M sub-frame gray signals is configured to sequentially provide the first through M-th sub-frame gray signals to the pixel array.

12. The apparatus of claim 10, wherein the means for providing the N sub-frame gray signals is configured to provide the first through M-th sub-frame gray signals to the pixel array in a reverse order.

13. The apparatus of claim 9, wherein the integer N corresponds to 2^{L}, L being an integer no less than two.

14. The apparatus of claim 13, wherein the means for providing the M sub-frame gray signals is configured to sequentially provide the first through M-th sub-frame gray signals to the pixel array.

15. The apparatus of claim 13, wherein the means for providing the M sub-frame gray signals is configured to provide the first through M-th sub-frame gray signals to the pixel array in a reverse order.

16. The apparatus of claim 9, wherein the means for providing the M sub-frame gray signals is configured to store a K-th sub-frame gray signal into the pixel array after the display time corresponding to the (K−1)-th sub-frame gray signal elapses, K being an integer no less than two and not greater than M.

17. An apparatus for displaying an image, the apparatus comprising:
a controller configured to generate M sub-frame gray data and a sub-frame synchronization signal based on received video data and a received video synchronization signal, each of the M sub-frame gray signals having N gray levels, N being an integer no less than two, N being an integer no less than three;
a data driver configured to convert the M sub-frame gray data into M sub-frame gray signals, and configured to provide the M sub-frame gray signals to a pixel array according to display times, the M sub-frame gray signals including first through M-th sub-frame gray signals, the display times respectively corresponding to each of the M sub-frame gray signals and being different from each other; and
a gate driver configured to provide scan signals to the pixel array in response to the sub-frame synchronization signal so that the M sub-frame gray signals are sequentially stored into the pixel array according to the display times.

18. The apparatus of claim 17, wherein the controller comprises:
a data memory device configured to store the received video data;
a sub-frame data generator configured to generate the M sub-frame gray data based on the stored video data; and
a timing controller configured to generate the sub-frame synchronization signal based on the received video synchronization signal.

19. The apparatus of claim 17, wherein the data driver comprises:
a latch circuit configured to receive the M sub-frame gray data by limits of rows;
a digital-to-analog converter configured to convert the received M sub-frame array data into the M sub-frame gray signals; and
an output buffer configured to provide the M sub-frame gray signals to the pixel array.

20. The apparatus of claim 19 wherein the output buffer is configured to sequentially provide the first M-th sub-frame gray signals to the pixel array.

21. The apparatus of claim 19, wherein the output buffer is configured to provide the first through M-th sub-frame gray signals to the pixel array in a reverse order.

22. The apparatus of claim 17, wherein the display time corresponding to a K-th sub-frame gray signal is proportional to N^{K}, K being an integer no less than one and not greater than M.

23. The apparatus of claim 22, wherein the integer N corresponds to 2^{L}, L being an integer no less than two.

24. A method for displaying an image comprising:
receiving video data;
generating M sub-frame gray signals based on the received video data, each of the M sub-frame gray signals having N gray levels, the M sub-frame gray signals including first through M-th sub-frame gray signals, M being an integer no less than two, N being an integer no less than three; and
displaying M sub-frame images based on the sub-frame gray signals according to display times to display the image, the display times respectively corresponding to each of the M sub-frame gray signals and being different from each other.

25. The method of claim 24, wherein the display time corresponding to a K-th sub-frame gray signal is proportional to N^{K}, K being an integer no less than one and not greater than M.

26. The method of claim 25, wherein the step of displaying the M sub-frame images comprises displaying the M sub-frame images by sequentially providing the first through M-th sub-frame gray signals to a pixel array.

27. The method of claim 25, wherein the step of displaying the M sub-frame images comprises displaying the M sub-frame images by providing the first through M-th sub-frame gray signals to a pixel array in a reverse order.

28. The method of claim 24, wherein the integer N corresponds to 2^{L}, L being an integer no less than two.

29. The method of claim 28, wherein the step of displaying the M sub-frame images comprises displaying the M sub-frame images by sequentially providing the first through M-th sub-frame gray signals to a pixel array.

30. The method of claim 28, wherein the step displaying the M sub-frame images comprises displaying the M sub-frame images by providing the first through M-th sub-frame gray signals to a pixel array in a reverse order.

31. An apparatus for displaying an image comprising:
means for receiving video data;
means for generating M sub-frame gray signals based on the received video data, each of the M sub-frame gray signals having N gray levels, the M sub-frame gray signals including first through M-th sub-frame gray signals, M being an integer no less than two, N being an integer no less than three; and
means for displaying M sub-frame images based on the M sub-frame gray signals according to display times to display the image, the display times respectively corresponding to each of the M sub-frame gray signals and being different from each other.

32. The apparatus of claim 31, wherein the display time corresponding to a K-th sub-frame gray signal of the M sub-frame gray signals is proportional to N^{K}, K being an integer no less than one and not greater than M.

33. The apparatus of claim 32, wherein the means for displaying the sub-frame images is configured to display the M sub-frame images by sequentially providing the first through M-th sub-frame gray signals to a pixel array.

34. The apparatus of claim 33, wherein the means for displaying the M sub-frame images is configured to display the M sub-frame images by providing the first through M-th sub-frame gray signals to a pixel array in a reverse order.

35. The apparatus of claim 31, wherein the integer N corresponds to 2^{L}, L being an integer no less than two.

36. The apparatus of claim 35, wherein the means for displaying the M sub-frame images is configured to display the M sub-frame images by sequentially providing the first through M-th sub-frame gray signals to a pixel array.

37. The apparatus of claim 35, wherein the means for displaying the M sub-frame images is configured to display the M sub-frame images by providing the first through M-th sub-frame gray signals to a pixel array in a reverse order.

38. An apparatus for displaying an image, comprising:
a pixel array;
a controller configured to generate M sub-frame gray data based on received video data each of the M sub-frame gray signals having N gray level, M being an integer no less than two, N being an integer no less than three;
a data driver configured to convert the M sub-frame gray data into M sub-frame gray signals, and configured to provide the M sub-frame gray signals to a pixel array according to display times, the M sub-frame gray signals including first through M-th sub-frame gray signals, the display times respectively corresponding to each of the M sub-frame gray signals and being different from each other; and
a gate driver configured to provide scan signals to the pixel array in response to the sub-frame synchronization signal so that the M sub-frame gray signals are sequentially stored into the pixel array according to the display times.

39. The apparatus of claim 38, wherein the controller comprises:
a data memory device configured to store the received video data;
a sub-frame data generator configured to generate the M sub-frame gray data based on the stored video data; and
a timing controller configured to generate a sub-frame synchronization signal based on a received video synchronization signal.

40. The apparatus of claim 38, wherein the data driver comprises:
a latch circuit configured to receive the M sub-frame gray data by a unit of a row;
a digital-to-analog converter configured to convert the received M sub-frame gray data into the M sub-frame gray signals; and
an output buffer configured to provide the M sub-frame gray signals to the pixel array.

41. The apparatus of claim 40, wherein the output buffer is configured to sequentially provide the first M-th sub-frame gray signals to the pixel array.

42. The apparatus of claim 40, wherein the output buffer is configured to provide the first through M-th sub-frame gray signals to the pixel array in reverse order.

43. The apparatus of claim 40, wherein the integer N corresponds to 2^{L}, L being an integer no less than two.

44. The apparatus of claim 43, wherein the output buffer is configured to sequentially provide the first M-th sub-frame gray signals to the pixel array.

45. The apparatus of claim 43, wherein the output buffer is configured to provide the first through M-th sub-frame gray signals to the pixel array in a reverse order.

46. The apparatus of claim 40, wherein the display time corresponding to a K-th sub-frame gray signal is proportional to N^{K}, K being an integer no less than one and not greater than M.

47. The apparatus of claim 46, wherein the integer N corresponds to 2^{L}, L being an integer no less than two.

48. The apparatus of claim 38, wherein the pixel array includes an active matrix organic light-emitting diode.
